(19) United States
(12) Patent Application Publication
(10) Pub. No.: US 2013/0033481 A1
(43) Pub. Date: Feb. 7, 2013

(54) LCD DEVICE AND DRIVING METHOD THEREOF

(71) Applicant: Chihtsung Kang, Shenzhen (CN)

(72) Inventor: Chihtsung Kang, Shenzhen (CN)

(73) Assignee: Shenzhen China Star Optoelectronics Technology Co., Ltd., Shenzhen (CN)

(21) Appl. No.: 13/376,591

(22) PCT Filed: Sep. 8, 2011
(86) PCT No.: PCT/CN2011/079486

§ 371 Date: Dec. 7, 2011

(30) Foreign Application Priority Data
Aug. 3, 2011 (CN) 201110220957.3

(51) Int. Cl. G09G 3/36; G09G 5/00

(52) U.S. Cl. 345/215; 345/87

(57) ABSTRACT

The present invention discloses an LCD device. The LCD device charges each pixel with a high voltage before writing into a correct data signal, that is, an over driving is performed before the correct data signal is written into the pixel. The present invention also discloses a driving method for the LCD device. Compared with the prior art, the frame buffer is not required in the present invention on one hand; the over driving can be performed without complex timing functions on another hand; and the incorrect twist angles of the liquid crystals which are driven instantaneously can be significantly avoided when using the conventional over driving by a look-up table for comparing two sequential image signals.

### FIELD OF THE INVENTION

The present invention relates to a display device, and especially to a liquid crystal display (LCD) device; and the present invention further relates to a driving method, and especially to a driving method for an LCD device.

### BACKGROUND OF THE INVENTION

Over driving is a technology used for improving a display effect of an LCD panel. Conventional over-driving technology generally utilizes a look-up table to find a predetermined interpolated voltage values by means of comparing two sequential image signals for increasing response speed. This technology requires using a frame buffer for storing a previous image and then comparing the previous image to a current image. Said predetermined interpolated voltage values are also required to be stored in a storage device; in addition, a time control register (TCON) is also required to cooperate thereof with the above-mentioned.

The over driving is shown in FIG. 1, in which a common electrode voltage of common lines is set as 5V, and an original signal is switched from 1V (voltages of positive and negative polarities are respectively 6V and 4V) to 3V (voltages of the positive and negative polarities are respectively 8V and 2V). In order to increase the response speed, a signal 5V (voltages of the positive and negative polarities are respectively 10V and 0V) is generally inserted into the original signal. When a voltage in a pixel is changed from 1V to 3V (i.e., grayscale switch), there is a frame time required to charge the pixel to get the 5V voltage.

In order to achieve high penetration, a designed pitch of strip electrodes in a pixel electrode is quite large in a conventional LCD device. If only a look-up table of interpolation is applied, incorrect twist angles of liquid crystals occur when the liquid crystals are driven instantaneously.

There is a significant need to provide an LCD device and a driving method thereof for solving the problem existing in the prior art.

### SUMMARY OF THE INVENTION

An objective of the present invention is to provide an LCD device, which can overcome the drawbacks that the over driving can not be realized in a frame time, and the frame buffer for storing is required, and the display effect is poor in the prior art.

To achieve the foregoing objective, an LCD device which is constructed in the present invention includes: an LCD panel on which a plurality of pixels is disposed for displaying images; a plurality of scanning lines coupled to the pixels; a plurality of data lines coupled to the pixels; a scan driver module, coupled to the scanning lines, utilized to set a pre-charging duration T1 of the pixel and an image showing duration T2 of the pixel and to transmit a scanning signal during a frame time T, so that a first data signal pre-charges the pixel before a second data signal for displaying the image is written into the pixel, wherein a value of the T is equal to a sum of values of the T1 and T2, and the values of the T1 and T2 are grater than 0, and the T1 precedes the T2, and the T1 and T2 are continuous; and a data driver module, coupled to the data lines, utilized to provide the first data signal to the pixel at a beginning of the pre-charging duration T1 so that the first data signal pre-charges the pixel, and utilized to provide the second data signal for displaying the image to the pixel at a beginning of the image showing duration T2. The scan driver module is utilized to transmit the first scanning signal to the pixel at the beginning of the pre-charging duration T1 so that the first data signal transmitted form the data driver module pre-charges the pixel, and utilized to transmit the second scanning signal to the pixel at the beginning of the image showing duration T2 so that the second data signal transmitted form the data driver module for displaying the image is written into the pixel. The scan driver module is utilized to transmit the third scanning signal to the pixel at the beginning of pre-charging duration T1 so that the first data signal transmitted form the data driver module pre-charges the pixel, and to keep transmitting the third scanning signal to the pixel at the beginning of the image showing duration T2 so that the second data signal transmitted form the data driver module for displaying the image is written into the pixel.

In the LCD device of the present invention, a duration T3 of the first scanning signal is less that the pre-charging duration T1 of the pixel.

In the LCD device of the present invention, a duration T4 of the third scanning signal is larger that the pre-charging duration T1.

Another objective of the present invention is to provide an LCD device, which can overcome the drawbacks that the over driving can not be realized in a frame time, and the frame buffer for storing is required, and the display effect is poor in the prior art.

To achieve the foregoing objective, an LCD device constructed in the present invention includes: an LCD panel on which a plurality of pixels is disposed for displaying images; a plurality of scanning lines coupled to the pixels; a plurality of data lines coupled to the pixels; a scan driver module, coupled to the scanning lines, utilized to set a pre-charging duration T1 of the pixel and an image showing duration T2 of the pixel and to transmit a scanning signal during a frame time T, so that a first data signal pre-charges the pixel before a second data signal for displaying the image is written into the pixel, wherein a value of the T is equal to a sum of values of the T1 and T2, and the values of the T1 and T2 are grater than 0, and the T1 precedes the T2, and the T1 and T2 are continuous; and a data driver module, coupled to the data lines, utilized to provide the first data signal to the pixel at a beginning of the pre-charging duration T1 so that the first data signal pre-charges the pixel, and utilized to provide the second data signal for displaying the image to the pixel at a beginning of the image showing duration T2.

In the LCD device of the present invention, The scan driver module is utilized to transmit the first scanning signal to the pixel at the beginning of the pre-charging duration T1 so that the first data signal transmitted form the data driver module pre-charges the pixel, and utilized to transmit the second scanning signal to the pixel at the beginning of the image showing duration T2 so that the second data signal transmitted form the data driver module for displaying the image is written into the pixel.

In the above-mentioned LCD device, a duration T3 of the first scanning signal is less that the pre-charging duration T1 of the pixel.

In the LCD device of the present invention, The scan driver module is utilized to transmit the third scanning signal to the pixel at the beginning of pre-charging duration T1 so that the first data signal transmitted form the data driver module pre-charges the pixel, and to keep transmitting the third scanning signal to the pixel at the beginning of the image showing duration T2 so that the second data signal transmitted form the data driver module for displaying the image is written into the pixel.

In the above-mentioned LCD device, a duration T4 of the third scanning signal is larger that the pre-charging duration T1.

Another objective of the present invention is to provide a driving method for an LCD device, which can overcome the drawbacks that the over driving can not be realized in a frame time, and the frame buffer for storing is required, and the display effect is poor in the prior art.

To achieve the foregoing objective, a driving method for an LCD device is constructed in the present invention. The LCD device includes a scan driver module, a data driver module, scanning lines, data lines, and an LCD panel. Pixels are disposed on the LCD panel. The scanning lines are coupled to the pixels and the scan driver module, and the data lines are coupled to the pixels and the data driver module. The method includes the steps of: (A) setting a pre-charging duration T1 of the pixel and an image showing duration T2 of the pixel by the scan driver module, wherein a value of a frame time T is equal to a sum of values of the T1 and T2, and the values of the T1 and T2 are grater than 0, and the T1 precedes the T2, and the T1 and T2 are continuous; (B) transmitting a scanning signal from the scan driver module to the pixel at a beginning of the pre-charging duration T1 so that a first data signal transmitted form the data driver module pre-charges the pixel; and (C) providing a second data signal for displaying images from the data driver module at a beginning of the image showing duration T2.

In the driving method for the LCD device of the present invention, the step (B) comprises: (b1) transmitting a first scanning signal from the scan driver module to the pixel at a beginning of the pre-charging duration T1 so that a first data signal transmitted form the data driver module pre-charges the pixel; and the step (B) further comprises: (b2) transmit the second scanning signal from the scan driver module to the pixel at the beginning of the image showing duration T2 so that the second data signal transmitted form the data driver module for displaying the image is written into the pixel.

In the above-mentioned driving method for the LCD device, a duration T3 of the first scanning signal is less that the pre-charging duration T1 of the pixel at the step (b1).

In the driving method for the LCD device of the present invention, the step (B) comprises: (b1) transmitting a third scanning signal from the scan driver module to the pixel at a beginning of the pre-charging duration T1 so that a first data signal transmitted form the data driver module pre-charges the pixel; and the step (B) further comprises: (b3) keeping transmitting the third scanning signal to the pixel at the beginning of the image showing duration T2 so that the data signal transmitted form the data driver module for displaying the image is written into the pixel.

In the above-mentioned driving method for the LCD device, a duration T4 of the third scanning signal is less that the pre-charging duration T1 of the pixel at the step (b3).

The advantageous effects of the present invention lie in: first, the frame buffer is not required in the present invention as compared to the prior art; second, the over driving can be performed without complex timing functions; moreover, the incorrect twist angles of the liquid crystals which are driven instantaneously can be significantly avoided when using the conventional over driving by the look-up table for comparing two sequential image signals.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a schematic drawing illustrating a row driving of an over driving in the prior art;

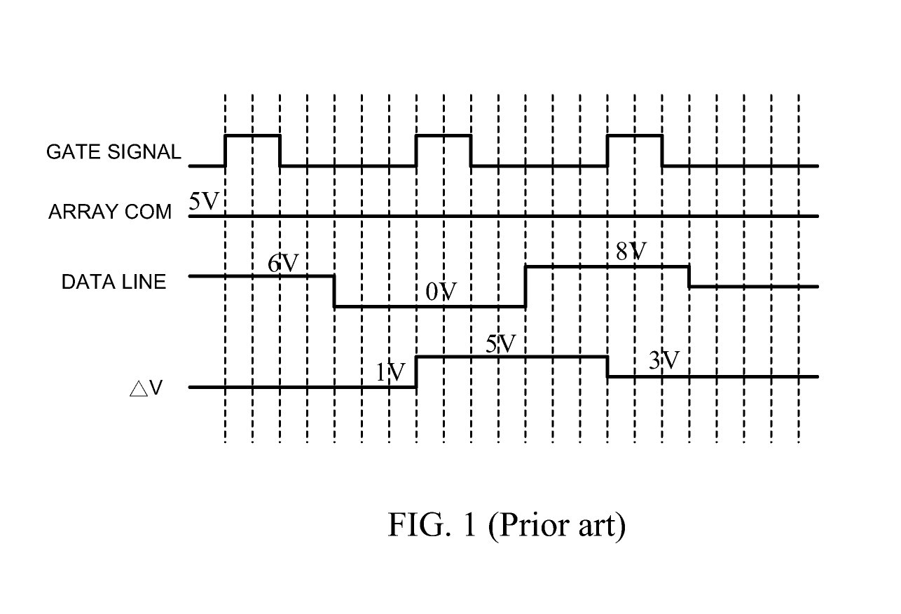

FIG. 2 is a schematic drawing illustrating an LCD panel of the present invention;

FIG. 3 is a schematic drawing illustrating a signal driving of the LCD device according to a first preferred embodiment of the present invention;

FIG. 4 is a schematic drawing illustrating a signal driving of the LCD device according to a second preferred embodiment of the present invention;

FIG. 5 is a flow chart illustrating a driving method of the LCD device according to the first preferred embodiment of the present invention; and

FIG. 6 is a flow chart illustrating a driving method of the LCD device according to the second preferred embodiment of the present invention.

### DETAILED DESCRIPTION OF THE PREFERRED EMBODIMENTS

Descriptions of the following embodiments refer to attached drawings which are utilized to exemplify specific embodiments. In different drawings, the same reference numerals refer to like parts throughout the drawings.

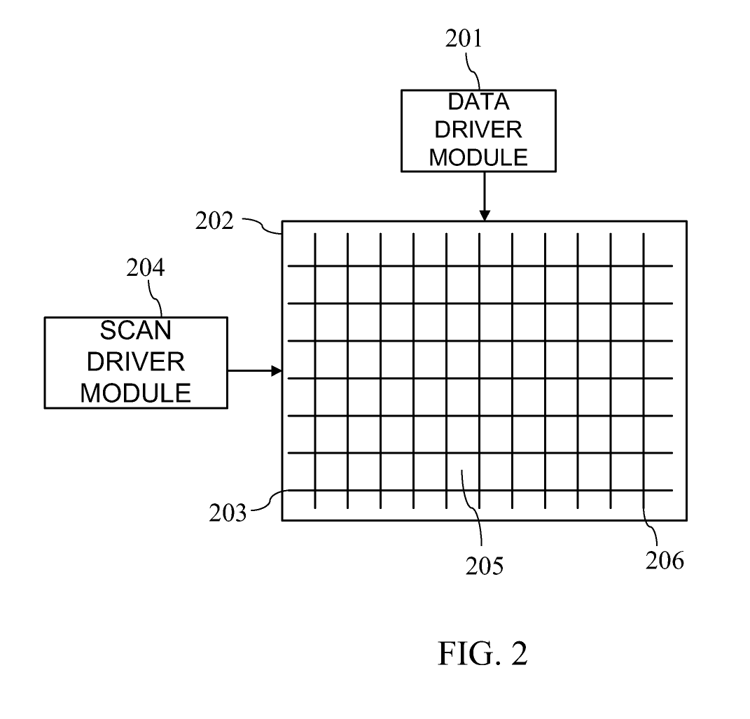

Referring to FIG. 2, FIG. 2 is a schematic drawing illustrating an LCD panel of the present invention. The LCD device of the present invention includes a scan driver module 204, a data driver module 201, an LCD panel 202, a plurality of scanning lines (gate lines) 203 and a plurality of data lines 206. There is a plurality of pixels 205 disposed on the LCD panel 202 for displaying images. The scanning lines 203 are coupled to the pixels 205, and the scan driver module 204 is coupled to the scanning lines 203. The data lines 206 are coupled to the pixels 205, and the data driver module 201 is coupled to the data lines 206. The scan driver module 204 is utilized to generate scanning signals, and the scanning signals are transmitted to the scanning lines 203 by the scan driver module 204. The data driver module 201 is utilized to generate data signals, and the data signals are transmitted to the data lines 206 by the data driver module 201. The scan driver module 204 is further utilized to set a pre-charging duration T1 of the pixel 205 and an image showing duration T2 of the pixel 205, in which T=T1+T2 is a frame time, and T1>0, T2>0, and the T1 precedes the T2, and the T1 and T2 are continuous, that is, the end of T1 is the beginning of T2. The data driver module 201 is further utilized to provide a first data signal to the pixel 205 coordinating with the scanning signal transmitted from the scan driver module 204 at the beginning of the T1 so as to pre-charge the pixel 205, and to provide a second data signal to the pixel 205 at the beginning of T2 so as to make the pixel 205 display the image according to the second data signal.

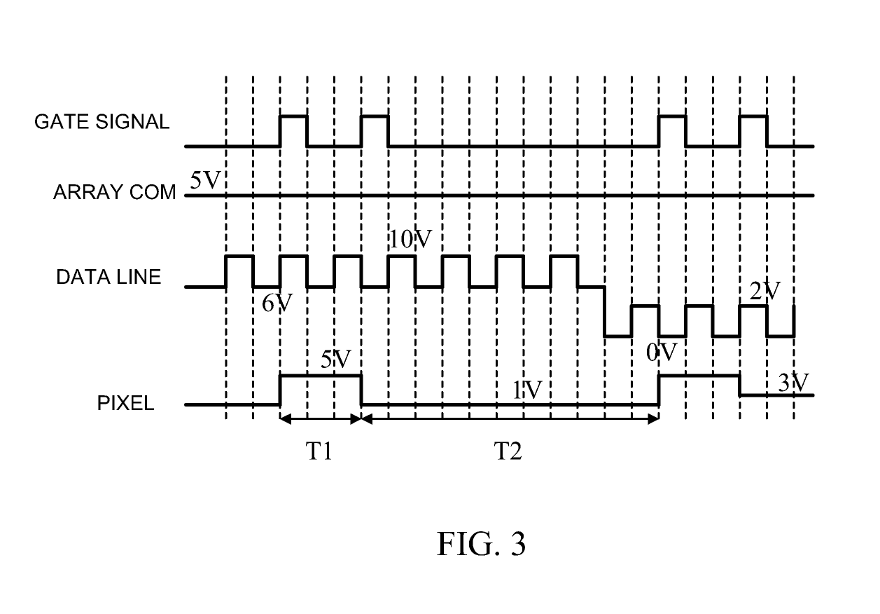

Referring to FIG. 3, FIG. 3 is a schematic drawing illustrating a signal driving of the LCD device according to a first preferred embodiment of the present invention. In the embodiment, the required time to scan a frame is T, and T=T1+T2, where T1 is the pre-charging duration of the pixel 205, and T2 is the image showing duration of the pixel 205. T1 and T2 are set by the scan driver module 204. Certainly, the data driver module 201 is also co-operated with the scan driver module 204 according to the T1 and T2 set by the scan driver module 204, that is, the data driver module 201 provides data signals to the pixel 205 coordinating with the scan driver module 204. In the case of maintaining a frame rate unchanged, a number of pulse signals of the scanning signal is doubled in one frame time, and a duration (scanning time) of each pulse signal is reduced to half of the original duration. A number of pulse signals of the data signal is appropriately increased in one frame time. 10V and 6V signals alternately appear in the data signal which is transmitted by the data driver module 201 via the data lines 206. Because the number of the pulse signals of the scanning signal is doubled in the frame time, the pixel 205 can be charged with 10V through the increased scanning and data signals. That is, the scan driver module 204 transmits a scanning signal to the pixel 205 via the gate lines (scanning lines) 203 so as to transmitting a scanning signal in advance before the data signal for displaying images is written into the pixel 205, whereby the data signal on the data lines pre-charges the pixel 205 with 10V. Specifically, at the beginning of the T1, the scan driver module 204 transmits a scanning signal, which is designated a first scanning signal. The first scanning signal is utilized to turn on a switch of the pixel 205. Accordingly, the first data signal, which is transmitted from the data driver module 201 coordinating with the scan driver module 204, can be inputted into the pixel 205, and the first data signal is utilized to pre-charge the pixel 205. At an end of the pre-charging duration T1, the scan driver module 204 transmits a scanning signal to the pixel 205, and the scanning signal is designated a second scanning signal. The second scanning signal is utilized to turn on the switch of the pixel 205 after pre-charging the pixel 205, so that the second data signal is inputted into the pixel 205. The second data signal is utilized to adjust a grayscale, that is, the second data signal makes the pixels 205 display the images. In the embodiment, the durations of the first scanning signal and the second scanning signal are T3, in which T3<T1<T. Accordingly, the over driving can be realized in a frame time. Compared with the prior art, the LCD device and the driving method of the present invention. Certainly, a ratio of the T1 and T2 can be adjusted arbitrarily as the driving desired. If a stronger over driving has to be realized for making the pixel 205 be charged with more electricity, the T1 can be extend.

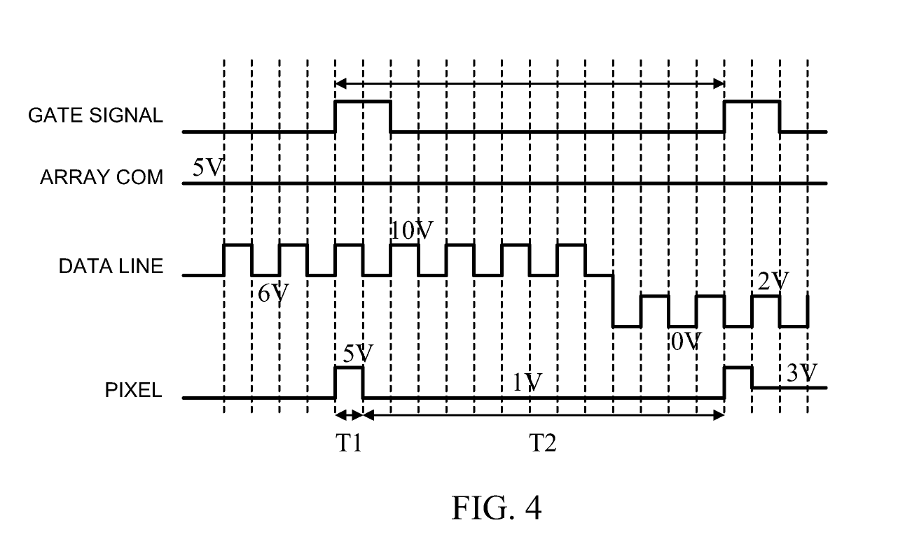

Referring to FIG. 4, FIG. 4 is a schematic drawing illustrating a signal driving of the LCD device according to a second preferred embodiment of the present invention. In the embodiment, the required time to scan a frame is T, and T=T1+T2, where T1 is the pre-charging duration of the pixel 205, and T2 is the image showing duration of the pixel 205. T1 and T2 are set by the scan driver module 204, and T1 and T2 can be set according to actual demand. In the case of maintaining a frame rate unchanged, a number of pulse signals of the scanning signal is unchanged in one frame time, and a number of pulse signals of the data signal is appropriately increased in one frame time. The scan driver module 204 transmits a scanning signal to the pixel 205 via the gate lines (scanning lines) 203 for making the data signal on the data lines 206 be written into the pixel 205. The data driver module 201 transmits the first data signal to the pixel 205 via the data lines 206 for charging the pixel 205. That is to say, the pixel 205 is pre-charged with a high voltage, and then the data signal for displaying the image is written into the pixel 205. Specifically, at the beginning of the T1, the scan driver module 204 transmits a scanning signal, which is designated a third scanning signal. The third scanning signal is utilized to turn on a switch of the pixel 205. Accordingly, the first data signal can be inputted into the pixel 205, and the first data signal is utilized to pre-charge the pixel 205. At the end of the pre-charging duration T1, the scan driver module 204 keeps transmitting the third scanning signal to the pixel 205. Meanwhile, the data driver module 201 transmits the second data signal to the pixel 205 coordinating with the scan driver module 204. The second data signal is utilized to adjust a grayscale, that is, the second data signal makes the pixels 205 display the images. In the embodiment, the duration of the third scanning signal is T4, in which T1<T4<T. Accordingly, the over driving can be realized in a frame time. In the process of switching the grayscale, Because the pixel have a pre-charged voltage, the incorrect twist angles of the liquid crystals which are driven instantaneously can be significantly avoided when using the conventional over driving through the look-up table for comparing two sequential image signals. In addition, the LCD device of the present invention doesn't have to increase a frame buffer for the over driving.

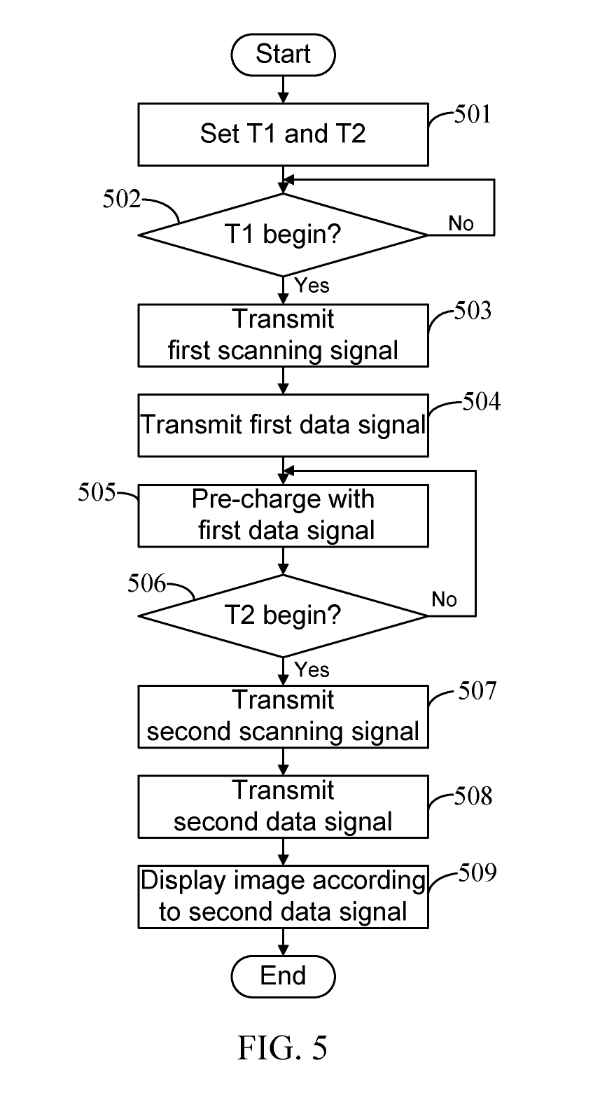

Referring to FIG. 5, FIG. 5 is a flow chart illustrating a driving method of the LCD device according to the first preferred embodiment of the present invention. At step 501, The scan driver module 204 is utilized to set a pre-charging duration T1 of the pixel 205 and an image showing duration T2 of the pixel 205, in which T=T1+T2 is a frame time, and T1>0, T2>0, and the T1 precedes the T2, and the T1 and T2 are continuous. The pre-charging duration T1 herein is a duration for the pixel 205 be pre-charged, and the showing duration is a duration for the pixel 205 to display images. The pre-charging duration T1 and the image showing duration T2, which set by the scan driver module 204 for the pixel 205, have a match with a clock signal. That is, the scan driver module 204 determines the beginning and end of the T1 as well as the beginning and end of the T2. At step 502, the scan driver module 204 determines whether it has reached the T1, if so, then performing step 503, if not, then keeping waiting. The scan driver module 204 determines whether it has reached the T1 in accordance with the clock signal. At step 503, at the beginning of the T1, the scan driver module 204 transmits a scanning signal, which is designated a first scanning signal. The first scanning signal is utilized to scan the pixel 205, i. e., to turn on a switch of the pixel 205. At step 504, at the beginning of the T1, the data driver module 201 transmits a data signal, which is designated a first data signal. The first data signal is utilized to pre-charge the pixel 205. At step 505, the pixel 205 is pre-charged with the first data signal until the end of the T1. At step 506, the scan driver module 204 determines whether it has reached the T2, if so, then performing step 507, if not, then keeping charging the pixel 205. The scan driver module 204 determines whether it has reached the T2 in accordance with the clock signal. At step 507, at the beginning of the T2, the scan driver module 204 transmits a scanning signal, which is designated a second scanning signal. The second scanning signal is also utilized to scan the pixel 205. At step 508, at the beginning of the T2, the data driver module 201 transmits a data signal, which is designated a second data signal. The second data signal is utilized to control the grayscale, i.e., to display the images for the pixel 205. At step 509, the pixel 205 displays the image according to the second data signal.

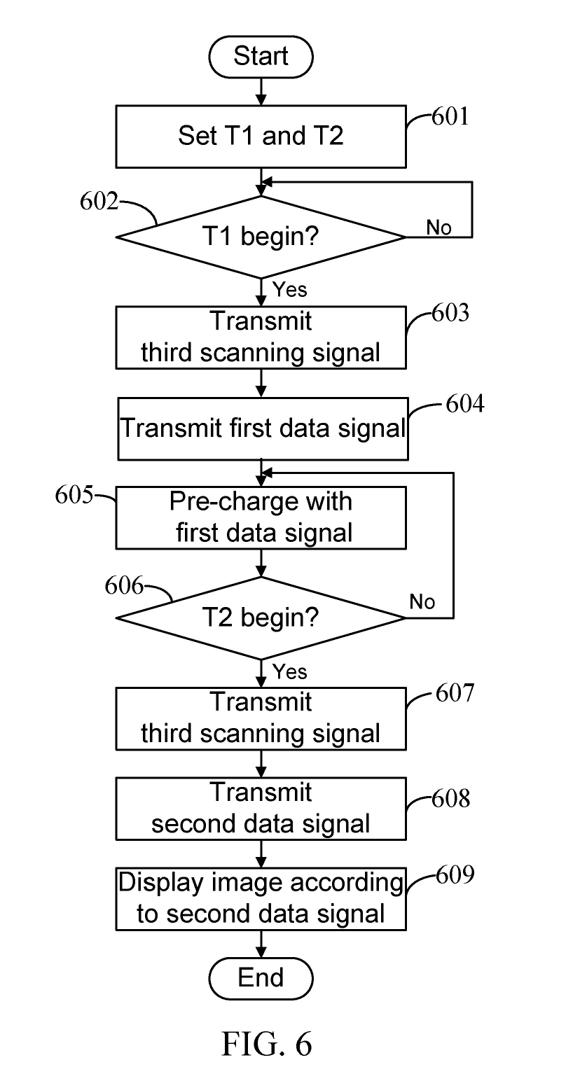

Referring to FIG. 6, FIG. 6 is a flow chart illustrating a driving method of the LCD device according to the second preferred embodiment of the present invention. At step 601, The scan driver module 204 is utilized to set a pre-charging duration T1 of the pixel 205 and an image showing duration T2 of the pixel 205, in which T=T1+T2 is a frame time, and T1>0, T2>0, and the T1 precedes the T2, and the T1 and T2 are continuous. The scan driver module 204 further sets a duration T4 of the scanning signal, which is designated a third scanning signal, and T1<T4<T. At step 602, the scan driver module 204 determines whether it has reached the T1, if so, then performing step 603, if not, then keeping waiting. The scan driver module 204 determines whether it has reached the T1 in accordance with the clock signal. At step 603, at the beginning of the T1, the scan driver module 204 transmits a third scanning signal, which is utilized to turn on the switch of the pixel 205 for providing the data signal to the pixel 205. At step 604, at the beginning of the T1, the data driver module 201 transmits the first data signal, which is utilized to pre-charge the pixel 205. At step 605, the pixel 205 is pre-charged with the first data signal until the end of the T1. At step 606, the scan driver module 204 determines whether it has reached the T2, if so, then performing step 607, if not, then keeping charging the pixel 205. The scan driver module 204 determines whether it has reached the T2 in accordance with the clock signal. At step 607, the scan driver module 204 keeps transmitting the third scanning signal to the pixel 205 during the T2, so as to make the switch of the pixel 205 turn on after the pre-charging. At step 608, at the beginning of the T2 the data driver module 201 transmits the second data signal. The second data signal is utilized to control the grayscale, i.e., to display the images for the pixel 205. At step 609, the pixel 205 displays the image according to the second data signal.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An LCD device, comprising:
an LCD panel on which a plurality of pixels is disposed for displaying images;
a plurality of scanning lines coupled to the pixels;
a plurality of data lines coupled to the pixels;
a scan driver module, coupled to the scanning lines, utilized to set a pre-charging duration T1 of the pixel and an image showing duration T2 of the pixel and to transmit a scanning signal during a frame time T, so that a first data signal pre-charges the pixel before a second data signal for displaying the image is written into the pixel, wherein a value of the T is equal to a sum of values of the T1 and T2, and the values of the T1 and T2 are grater than 0, and the T1 precedes the T2, and the T1 and T2 are continuous; and
a data driver module, coupled to the data lines, utilized to provide the first data signal to the pixel at a beginning of the pre-charging duration T1 so that the first data signal pre-charges the pixel, and utilized to provide the second data signal for displaying the image to the pixel at a beginning of the image showing duration T2;
wherein the scan driver module is utilized to transmit the first scanning signal to the pixel at the beginning of the pre-charging duration T1 so that the first data signal transmitted form the data driver module pre-charges the pixel, and utilized to transmit the second scanning signal to the pixel at the beginning of the image showing duration T2 so that the second data signal transmitted form the data driver module for displaying the image is written into the pixel;
wherein the scan driver module is utilized to transmit the third scanning signal to the pixel at the beginning of pre-charging duration T1 so that the first data signal transmitted form the data driver module pre-charges the pixel, and to keep transmitting the third scanning signal to the pixel at the beginning of the image showing duration T2 so that the second data signal transmitted form the data driver module for displaying the image is written into the pixel.

2. The LCD device according to claim 1, wherein a duration T3 of the first scanning signal is less that the pre-charging duration T1 of the pixel.

3. The LCD device according to claim 1, wherein a duration T4 of the third scanning signal is larger that the pre-charging duration T1 of the pixel.

4. An LCD device, comprising:
an LCD panel on which a plurality of pixels is disposed for displaying images;
a plurality of scanning lines coupled to the pixels;
a plurality of data lines coupled to the pixels;
a scan driver module, coupled to the scanning lines, utilized to set a pre-charging duration T1 of the pixel and an image showing duration T2 of the pixel and to transmit a scanning signal during a frame time T, so that a first data signal pre-charges the pixel before a second data signal for displaying the image is written into the pixel, wherein a value of the T is equal to a sum of values of the T1 and T2, and the values of the T1 and T2 are grater than 0, and the T1 precedes the T2, and the T1 and T2 are continuous; and
a data driver module, coupled to the data lines, utilized to provide the first data signal to the pixel at a beginning of the pre-charging duration T1 so that the first data signal pre-charges the pixel, and utilized to provide the second data signal for displaying the image to the pixel at a beginning of the image showing duration T2. and utilized to provide the second data signal for displaying the image to the pixel at a beginning of the image showing duration T2.

5. The LCD device according to claim 4, wherein the scan driver module is utilized to transmit the first scanning signal to the pixel at the beginning of the pre-charging duration T1 so that the first data signal transmitted form the data driver module pre-charges the pixel, and utilized to transmit the second scanning signal to the pixel at the beginning of the image showing duration T2 so that the second data signal transmitted form the data driver module for displaying the image is written into the pixel.

6. The LCD device according to claim 5, wherein a duration T3 of the first scanning signal is less that the pre-charging duration T1 of the pixel.

7. The LCD device according to claim 4, wherein the scan driver module is utilized to transmit the third scanning signal to the pixel at the beginning of pre-charging duration T1 so that the first data signal transmitted form the data driver module pre-charges the pixel, and to keep transmitting the third scanning signal to the pixel at the beginning of the image showing duration T2 so that the second data signal transmitted form the data driver module for displaying the image is written into the pixel.

8. The LCD device according to claim 7, wherein a duration T4 of the third scanning signal is larger that the pre-charging duration T1 of the pixel.

9. A driving method for an LCD device, the LCD device comprising a scan driver module, a data driver module, scanning lines, data lines, and an LCD panel, pixels disposed on the LCD panel, the scanning lines coupled to the pixels and the scan driver module, the data lines coupled to the pixels and the data driver module, the method comprising the steps of:
(A) setting a pre-charging duration T1 of the pixel and an image showing duration T2 of the pixel by the scan driver module, wherein a value of a frame time T is equal to a sum of values of the T1 and T2, and the values of the T1 and T2 are grater than 0, and the T1 precedes the T2, and the T1 and T2 are continuous;
(B) transmitting a scanning signal from the scan driver module to the pixel at a beginning of the pre-charging duration T1 so that a first data signal transmitted form the data driver module pre-charges the pixel; and
(C) providing a second data signal for displaying images from the data driver module at a beginning of the image showing duration T2.

10. The driving method for the LCD device according to claim 9, wherein the step (B) comprises:
(b1) transmitting a first scanning signal from the scan driver module to the pixel at a beginning of the pre-charging duration T1 so that a first data signal transmitted form the data driver module pre-charges the pixel;
and the step (B) further comprises:
(b2) transmit the second scanning signal from the scan driver module to the pixel at the beginning of the image showing duration T2 so that the second data signal transmitted form the data driver module for displaying the image is written into the pixel.

11. The driving method for the LCD device according to claim 10, wherein a duration T3 of the first scanning signal is less that the pre-charging duration T1 of the pixel at the step (b1).

12. The driving method for the LCD device according to claim 9, wherein the step (B) comprises:
(b1) transmitting a third scanning signal from the scan driver module to the pixel at a beginning of the pre-charging duration T1 so that a first data signal transmitted form the data driver module pre-charges the pixel;
and the step (B) further comprises:
(b3) keeping transmitting the third scanning signal to the pixel at the beginning of the image showing duration T2, so that the data signal transmitted form the data driver module for displaying the image is written into the pixel.

13. The driving method for the LCD device according to claim 12, wherein a duration T4 of the third scanning signal is larger that the pre-charging duration T1 of the pixel at the step (b3).
